(19) United States
(12) Patent Application Publication
(10) Pub. No.: US 2013/0031761 A1
(43) Pub. Date: Feb. 7, 2013

(54) BINDER SPINE LABEL INSERT REMOVER

(71) Applicant: Sertsai A. SEYOUM, Calgary (CA)

(72) Inventor: Sertsai A. SEYOUM, Calgary (CA)

(21) Appl. No.: 13/198,282

(22) Filed: Aug. 4, 2011

(51) Int. Cl. B25B 27/14; B23P 11/00

(52) U.S. Cl. 29/426.1; 29/278

(57) ABSTRACT

A tool for removing a labeling insert on a spine of a binder is disclosed. The tool includes a semi rigid metal or plastic to remove labels from a binder spine slot. The remover includes a first end portion having a slightly protruding hook, where the remover pierce through and hook into a binder label. It also includes a second end portion, an attached handgrip for pulling the label remover to remove a binder label. The first and second portions are attached to the remover as a single unit.

### FIELD OF THE INVENTION

The present invention relates to a new label remover and method for removing a label from a label insert slot on a spine of a loose-leaf binder.

### DESCRIPTION OF THE RELATED ART

Loose-leaf binders and other bound works may be conveniently provided with transparent overlays on their spines that are sealed along longitudinal edges of the spine. An elongated pocket or slot is defined between the cover and spine into which a label may be inserted to identify the contents of the bound work. A label attached in such manner is protected from wear and tear by the durable overlay.

A label is difficult to remove from a binder slot due to the length of a slot, and the fact that an overlay fits tightly over the spine. Attempts to remove a label from a slot will generally result in tear, fold, or the separation of the overlay by the force used to pull a label from a slot. Additional damage may also be done to the binder spine and/or overlay if a pen, paper clip, or similar sharp objects are used to force a label of a slot.

### SUMMARY OF THE INVENTION

Embodiments herein include a new tool for removing a label from a spine of bound works. One embodiment includes a flexible label remover to remove labels from a binder slot. The remover has a first end portion having a hook or hooks section for attaching a binder label thereto. It also has a second end portion for pulling the label, attached to the first end portion, from a binder slot. The first or second end portions are not detachable from the remainder of the remover.

Accordingly, in one broad, aspect a flexible label remover for removing a label insert from a slot of a binder spine is provided. The label remover comprises a first end portion having at least one protruding hook. The at least one hook pierces a surface of the label and thereby attaches the label to the label remover. The label remover also comprises a second end portion for pulling the label remover and the label attached to the first end portion of the label remover out of the slot. The label remover further comprises a middle portion between the first end portion and the second end portion. The middle portion connects the first end portion and the second end portion.

Accordingly, in another broad aspect, a method for removing a label from a slot in the spine of a bound work is provided. The method comprises providing a label remover having a first end portion and a second end portion. The first end portion has at least one hook. The first end portion of the label remover is inserted into the slot. The second portion protrudes from the slot when the first end portion is inserted into the slot. A surface of the label is pierced with the at least one hook such that the label attaches itself to the label remover. The label attached to the label remover is removed from the slot by gripping the second end portion and pulling out the label remover and the label attached to the label remover from the slot.

### BRIEF DESCRIPTION OF THE DRAWINGS

FIG. 1 is a perspective view of a label remover inserted into a slot on the spine of a loose-leaf binder according to one embodiment;

FIG. 2 is a side elevation view of the binder and the label remover of FIG. 1

FIGS. 3a to 3d are simplified front elevation views illustrating removal of a label insert from the slot of the binder using the label remover of FIG. 1;

FIG. 4 is a duplicate of FIG. 1;

FIG. 5 is a flowchart illustrating the steps of removing a label insert from the slot of the binder using the label remover of FIG. 1; and

FIGS. 6a and 6b are front and side elevation views of the label remover of FIG. 1.

### DETAILED DESCRIPTION OF THE INVENTION

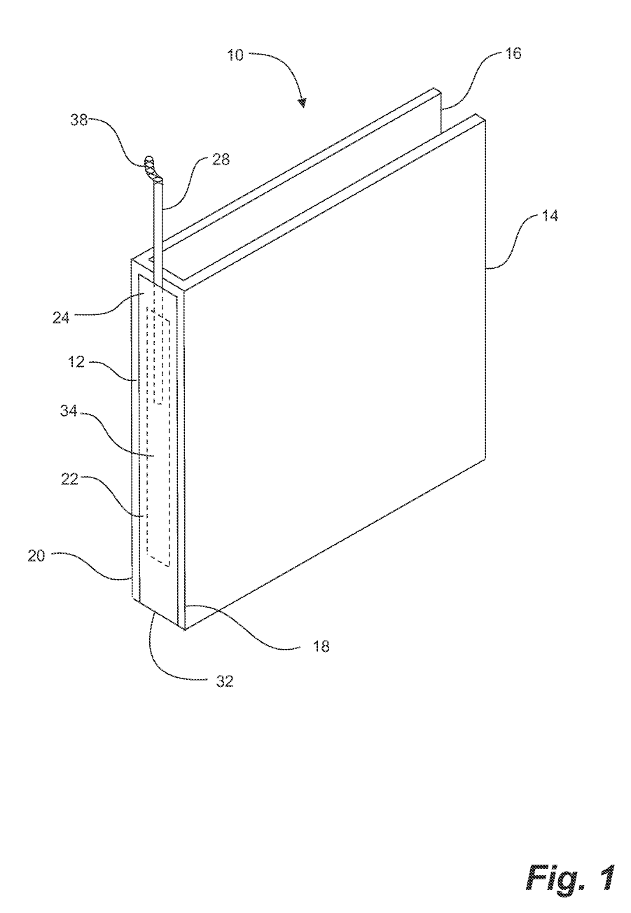

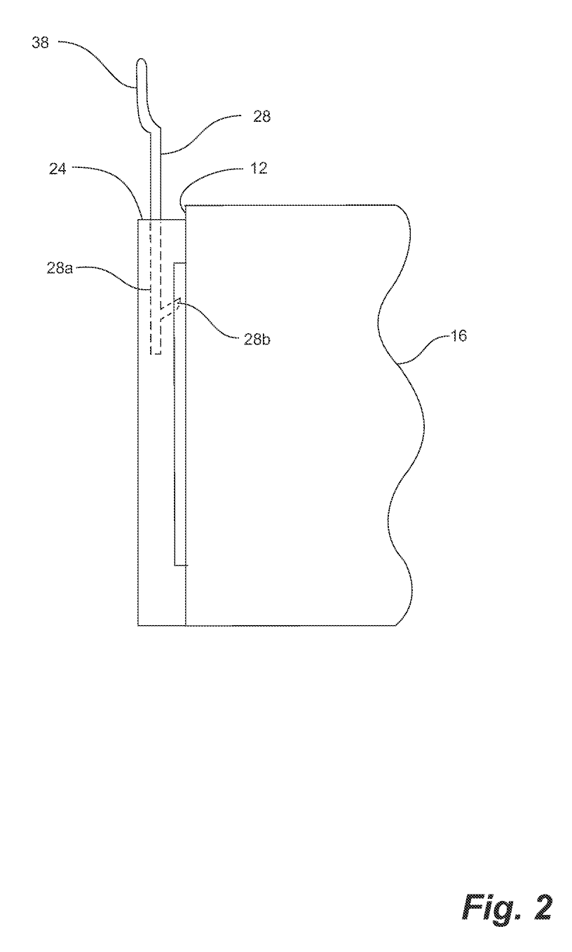

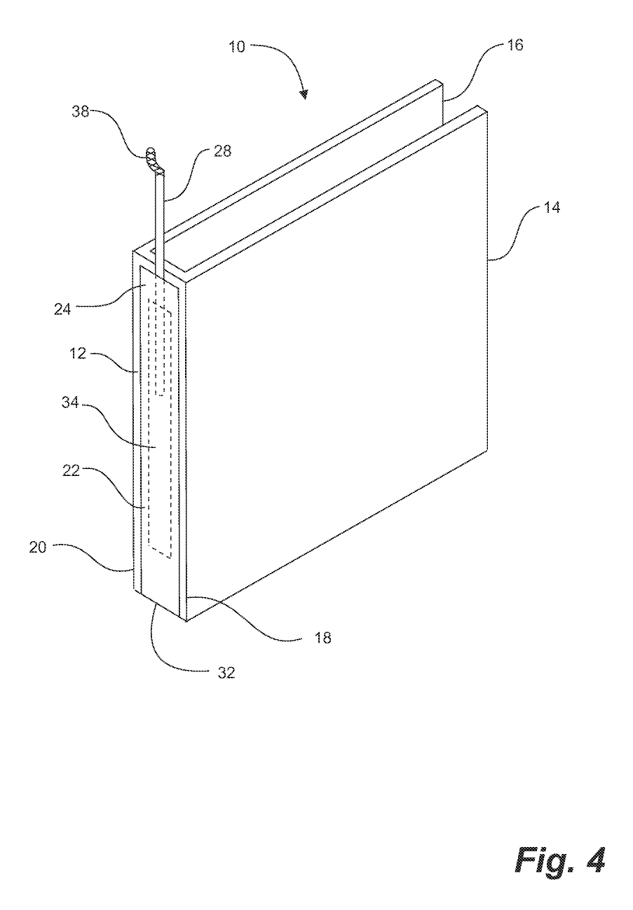

A label remover 28 disclosed herein is illustrated in FIGS. 1, 4 and 2. The label remover has been referred to as an arrangement or a tool or a label remover assembly herein.

A bound work is shown herein as being a loose-leaf binder 10. The binder 10 is comprised of a spine or end cover 24 with a pair of parallel longitudinal edges 18 and 20 and a pair of parallel transverse edges 30 and 32. Front and rear covers 14 and 16, respectively, are attached to the spine along each longitudinal edge with hinges located at the spines longitudinal edges 18 and 20, between the covers 14 and 16 and the spine 12. A transparent or semitransparent cover or overlay 22 is located on the spine 12 and sealed to the spine along the longitudinal edges 18 and 20, and transverse edge 32, forming a one end non-sealed slot 24 between the spine 12 and the overlay cover 22.

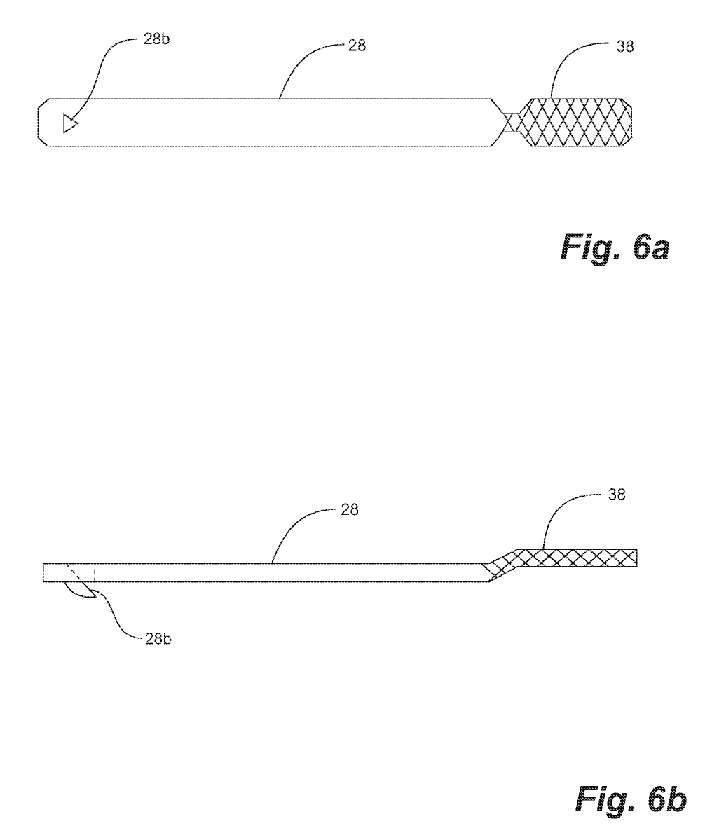

With reference to FIGS. 6a and 6b, the label remover 28 has a first end portion having a protruding hook or hook section 28b. The label has a second end portion or an upper end which is provided with a handgrip 38. The handgrip can be a silicon epoxy handgrip. The first end portion and the second end portion is connected by a middle portion. The label remover 28 is thin and flexible and can be made of plastic or steel. The hook is triangular and protrudes outwardly from the label remover.

In order to enable a label or label insert 34 made of flexible paper or the like to be removed from the slot 24 of the binder 10, the thin, flexible label remover 28 is extended through the slot 24 and the label in the slot 24 is hooked to the label remover. As viewed in FIG. 1, the upper end of the remover 28 having the handgrip 38, sticks out of the binder 10 spine label overlay. The lower end or the first end portion of the remover 28 is attached to the label of the binder 10, to remove the label from the slot 24.

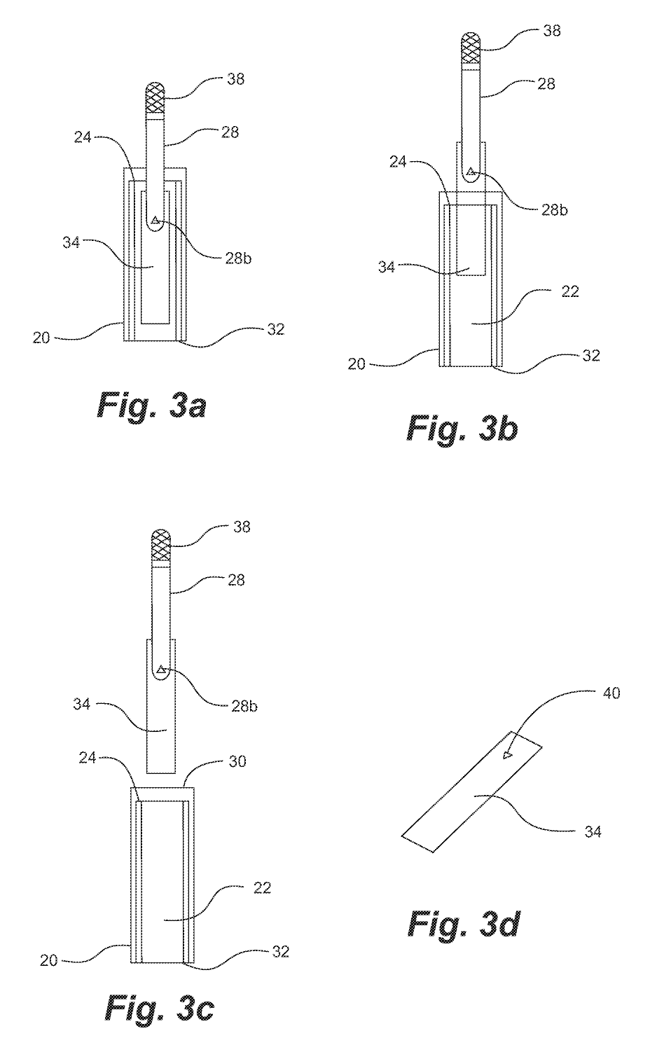

FIGS. 3a to 3d are simplified diagrams illustrating how the label remover 28 is used to remove the label from the slot 24. These figures, as well as similar figures, which will be referenced below, are not drawn to scale, but are compressed along the axis of the spine 12 to facilitate description of the invention.

In operation, the hook section 28b of the flexible label remover is attached to a surface of the label 34 and the label remover is then used to pull the label from the binder slot. The label remover is then removed from the label by sliding the remover in opposite direction of the handgrip 38. This will prevent the possibilities of the label from being damaged when the label remover is unhooked from it. As seen in FIG. 3d, when the label remover is removed from the label a hole 40 is formed in the label where the hook 28b pierces the label.

The directions included with overlay binders, which are sold to the public including spine labels, advise that the step of FIG. 3a should be performed by popping the label remover 28 to hook to the label 34 using a gentle upward motion. No problems will be encountered if the directions are followed. However, users who don't receive or read the directions or who are careless and/or impatient tend to jerk on the remover 28 rather than hook the label 34 gently as advised. if the label remover 28 is jerked rather than gently hooked, part of the label 34 can shear and be torn off and can remain inside the slot 24.

Also, the label 34 needs to be hooked to the label remover 28 so that both are in a longitudinal alignment. This allows the label 34 to be more easily pulled out of the slot by the label remover 28. If they are not aligned properly, the edges of the label 34 can hit the slot edges preventing the label 34 from being pulled out of the slot or damaging the label.

The label remover may sometimes tear away part of the label when the label remover and the label are separated, damaging the label. Also, the label and the label remover can get hooked to the binder spine on the longitudinal alignment making it difficult to pull the label from the slot.

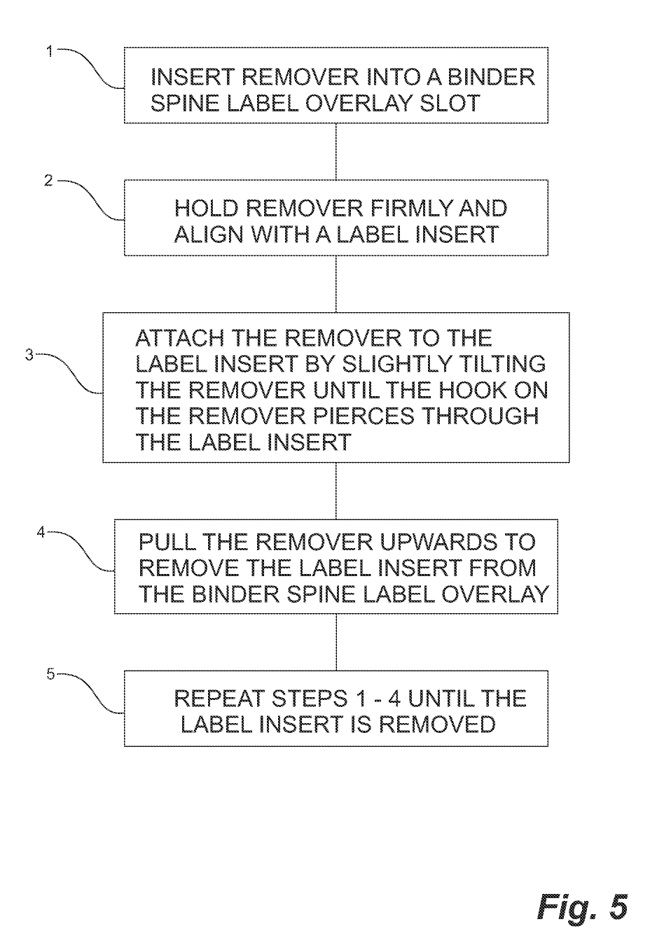

With reference to FIG. 5, the label 34 from the spine slot 24 is removed by inserting the label remover 28 into the binder slot 24. The label remover 28 is held firmly and aligned with the label 34. The label remover 28 is attached to the label by slightly tilting the label remover until the hook 28b on the label remover pierces the label. The label remover is pulled upwards to remove the label remover and the label attached to the label remover from the binder slot. The label remover is then removed from the label by sliding the label remover in opposite direction of the handgrip 38.

The label remover 28 can be used with many different types of binders with the binder 10 being a standard loose-leaf binder. The slot 24 is sized to accept flexible labels made of paper or the like, which are generally undersized as compared to the length and width of the slot 24. The label remover is narrower than the label, typically 1.27 cm (½ inches) wide and 12.7 cm (5 inches) long, and made of flexible plastic or steel or other suitable material. The label remover is inserted in the slot 24 and extends beyond the sealed transverse edges 30 of the spine 12 when the label is attached to the first end portion of the label remover.

The label remover is very effective in removing the label from the binder spine label transparent overlay slot.

In summary a flexible label remover is provided to pull out a label insert from a binder spine slot which comprises first end portion having slightly protruding hook to pierce and hook a binder spine label insert, second end portion to pull the said label insert attached to said first end portion out of the binder slot, and middle portion between said first and second portions, said middle connects the first and second end portions.

The first end portion can have a protruding hook or hooks from the said first end to allow the binder label insert to attach to the remover. The hook or hooks are not detachable from the said portion.

The label remover further comprises a flexible metal or plastic strip and a silicon epoxy handgrip or the like. A first end portion which extends through a slot; a second end portion which protrudes from said top transverse end of a slot. The label remover has silicon epoxy handgrip to pull out a binder spine label insert.

The first end portion and second end portion of the label remover are sufficiently long enough to attach to a label insert inside binder spine label slot.

Means for removing a label insert includes a hook or hooks to said end portion.

The flexible label remover is made of steel or plastic.

I claim:

1. A flexible label remover for removing a label insert from a slot of a binder spine, the label remover comprising:
a first end portion having at least one protruding hook, the at least one hook piercing a surface of the label and thereby attaching the label to the label remover;
a second end portion for pulling the label remover and the label attached to the first end portion of the label remover out of the slot; and
a middle portion between the first end portion and the second end portion, the middle portion connecting the first end portion and the second end portion.

2. The label remover of claim 1, wherein the at least one hook is not detachable from the first end portion.

3. The label remover of claim 1, wherein the label remover is made of steel.

4. The label remover of claim 1, wherein the label remover is made of plastic.

5. The label remover of claim 1, wherein when the first end portion pierces the surface of the label, the second end portion protrudes from the slot.

6. The label remover of claim 1, wherein the second end portion is provided with a handgrip.

7. The label remover of claim 6, wherein the handgrip is a silicon epoxy handgrip.

8. The label remover of claim 1, wherein the label remover is narrower than the label.

9. The label remover of claim 1, wherein the at least one hook is triangular and protrudes outwardly from the label remover.

10. A method for removing a label from a slot in the spine of a bound work, the method comprising:
providing a label remover having a first end portion and a second end portion, the first end portion having at least one hook;
inserting the first end portion of the label remover into the slot, the second portion protruding from the slot when the first end portion is inserted into the slot;
piercing a surface of the label with the at least one hook such that the label attaches itself to the label remover; and
removing the label attached to the label remover from the slot by gripping the second end portion and pulling out the label remover and the label attached to the label remover from the slot.

11. The method of claim 10 further comprising attaching the label to the at least one hook by aligning the label with the label remover and tilting the label remover until the at least one hook pierces the surface of the label.

12. The method of claim 10 further comprising removing the label attached to the label remover by sliding the label remover in a direction opposite to the second end portion.
